(19) United States
(12) Patent Application Publication
(10) Pub. No.: US 2012/0047049 A1
(43) Pub. Date: Feb. 23, 2012

(54) SYSTEM AND METHOD FOR PROVISIONING PHARMACEUTICAL INVENTORY

(76) Inventor: Jarrett Cadiz, Southlake, TX (US)

(21) Appl. No.: 13/215,200

(22) Filed: Aug. 22, 2011

Related U.S. Application Data
(60) Provisional application No. 61/442,789, filed on Feb. 14, 2011.
(60) Provisional application No. 61/406,682, filed on Dec. 17, 2010.
(60) Provisional application No. 61/413,281, filed on Nov. 12, 2010.
(60) Provisional application No. 61/375,421, filed on Aug. 20, 2010.

(51) Int. Cl. G06Q 10/00

(52) U.S. Cl. 705/28

(57) ABSTRACT

Systems and methods are disclosed for provisioning a pharmaceutical inventory including pharmaceutical products. In one embodiment, a local monitoring subsystem located at a medical office includes an interface configured to input data relative to the pharmaceutical inventory, including information about the removal, reduction, recall, and addition of pharmaceutical products. A disbursed tracking subsystem is distributed through the medical office, a remote server, vendor, and distributor in order to store inventory data about the pharmaceutical inventory. A reconcile engine associated with the remote server compares the input data and the inventory data to determine reorder times for the pharmaceutical inventory. Also, the reconcile engine monitors the shelf life and expiration of the pharmaceutical products, including injectable drugs, peroral drugs, oral drugs, topical drugs, transmucosal drugs, transdermal drugs, sublingual drugs, intranasal drugs, and inhalant drugs.

### PRIORITY STATEMENT

This application, filed in the name of Jarrett Cadiz, an individual residing in Southlake, Tex., claims benefit priority from co-pending (1) U.S. Provisional Patent Application No. 61/442,789, entitled “System And Method For Provisioning Pharmaceutical Inventory” and filed on Feb. 14, 2011 in the name of Jarrett Cadiz; (2) U.S. Provisional Patent Application No. 61/406,682, entitled “System and A Method for Controlling and Processing Pharmaceutical Sample Inventory Information Associated with a Medical Entity and filed on Dec. 17, 2010 in the name of Jarrett James Cadiz; (3) U.S. Provisional Patent Application No. 61/413,281, entitled “System and Method for Pharmaceutical Sample Inventory Information at a Medical Entity” and filed on Nov. 12, 2010 in the name of Jarrett James Cadiz; and (4) U.S. Provisional Patent Application No. 61/375,421, entitled “Computer Application for Organizing and Tracking Sample Inventory” and filed on Aug. 20, 2010, in the name of Jarrett James Cadiz; all of which are hereby incorporated by reference for all purposes.

### TECHNICAL FIELD OF THE INVENTION

This invention relates, in general, to supply chain management and, in particular, to systems and methods for provisioning pharmaceutical inventory, including managing the administration of pharmaceutical products.

### BACKGROUND OF THE INVENTION

Inventory management is a component of most supply chain management systems. With respect to pharmaceutical inventory, inventory management enables doctors and health care providers to keep track of how much inventory has been received and distributed to patients. Moreover, with respect to costs, management of pharmaceutical inventory is a balancing act between meeting the needs of patients and optimizing the drugs on the shelves, in cabinets, in refrigerators, and other storage locations. With ever tightening cost controls, it is critical to accurately gauge the inventory of pharmaceutical products, including injectable drugs, peroral drugs, oral drugs, topical drugs, transmucosal drugs, transdermal drugs, sublingual drugs, intranasal drugs, and inhalant drugs, regardless of purpose, including chemotherapy and vaccines. Such constraints to eliminate waste and inefficiency in healthcare necessitate new systems and methods for provisioning pharmaceutical inventory.

### SUMMARY OF THE INVENTION

It would be advantageous to achieve systems and methods for provisioning pharmaceutical inventory to enable doctors and health care providers to keep track of how much inventory is available for patients. It would also be desirable to enable an electronic solution that mitigates the risk of human error often associated with supply chain management. To better address one or more of these concerns, in one aspect of the invention, one embodiment of a system for provisioning pharmaceutical inventory is presented. In this particular embodiment, a local monitoring subsystem located at a medical office includes an interface configured to input data relative to the pharmaceutical inventory, including information about the removal (along with recall), reduction, and addition of pharmaceutical products. A disbursed tracking subsystem is distributed through the medical office, a remote server, vendor, and distributor in order to store inventory data about the pharmaceutical inventory. A reconcile engine associated with the remote server compares the input data and the inventory data to determine reorder times for the pharmaceutical inventory. Also, the reconcile engine monitors the shelf life and expiration of the pharmaceutical products/items, including injectable drugs, peroral drugs, oral drugs, topical drugs, transmucosal drugs, transdermal drugs, sublingual drugs, intranasal drugs, and inhalant drugs, to include drugs administered by any means of administration and, to include, by any product that effects an animal's body. These and other aspects of the invention will be apparent from and elucidated with reference to the embodiment(s) described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a component block diagram of one embodiment of a system for the provisioning of pharmaceutical inventory;

FIG. 2 is a communication block diagram of one embodiment of a system for the provisioning of pharmaceutical inventory;

FIG. 3 is a data flow diagram of one embodiment of the system for the provisioning of pharmaceutical inventory;

FIG. 4A is a flow chart depicting a method for data entry of pharmaceutical products;

FIG. 4B is a flowchart depicting a method for data clean up;

FIG. 4C is a flowchart depicting a method for entering and/or editing pharmaceutical product data;

FIG. 4D is a flowchart depicting a method for manually ordering pharmaceutical products;

FIG. 4E is a flowchart depicting a method for handling a feedback report;

FIG. 4F is a flowchart depicting a method for automatic order placement; and

FIG. 4G is a flowchart depicting a method for entering order data.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

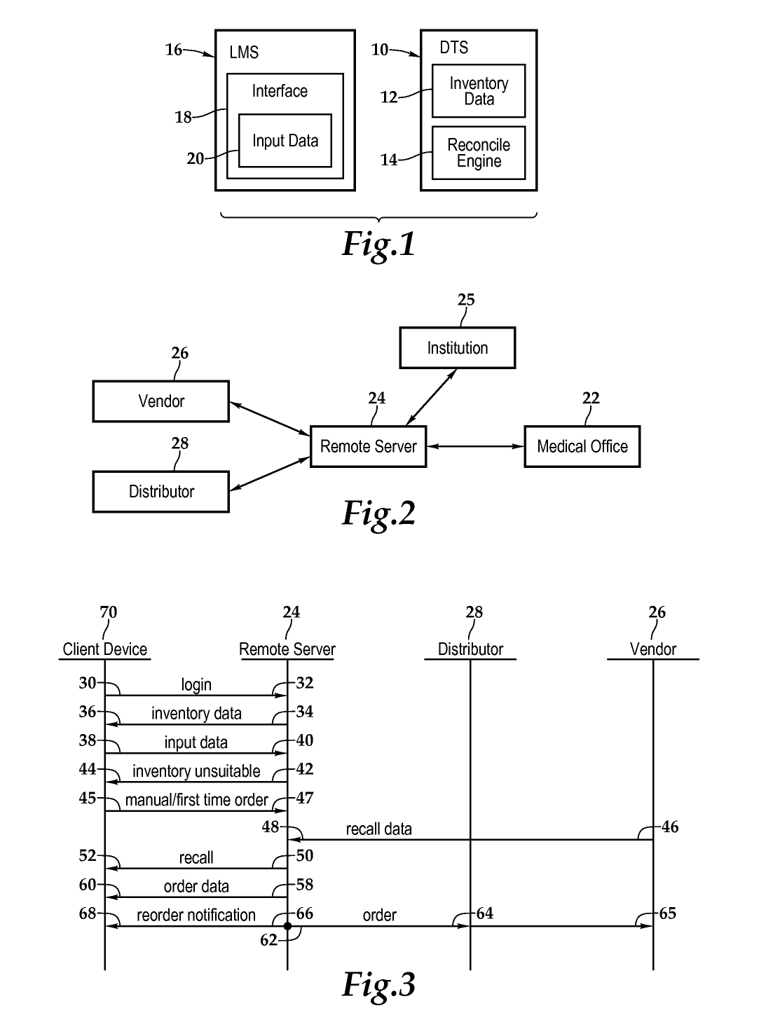

Referring to FIGS. 1 and 2, therein is depicted a component block diagram and a communication block diagram of one embodiment of a system for the provisioning of pharmaceutical inventory. A local monitoring subsystem 16 is located at a medical office 22. Order interface 18 is configured to input data relative to the pharmaceutical inventory. An order for a pharmaceutical product can be a manual order, a first time order, an automatic order, or a reorder. Such input data may include information about the removal, reduction, and the addition of pharmaceutical products. Orders within the system can be manually entered via order interface 18 and can also be automatically entered, such as via a subscription, as further detailed below. The interface 18 may be connected to or located in communication with electronic medical records or any other computerized medical records contained or accessible by any system in an organization to assist with the delivery of care.

A disbursed tracking system 10 is distributed through the medical office 22, a remote server 24, a vendor 26, and a distributor 28. The disbursed tracking subsystem 10 includes a memory that stores inventory data 12 about the pharmaceutical inventory. By way of example, the inventory data may include information about the production, distribution, shipping, transit, and consumption of the pharmaceutical inventory.

A reconcile engine 14 is associated with the remote server 24 and located in communication with the local monitoring subsystem 16 in order to compare the input data and the inventory data to determine reorder times for the pharmaceutical inventory. The reconcile engine 14 monitors the shelf life and expiration of the pharmaceutical products. The pharmaceutical products may include drug samples and various injectable drugs, peroral or oral drugs (administered through the mouth), topical drugs (administered via the skin), transmucosal drugs (administered nasally, buccally/sublingually, vaginally, ocularly and rectally), transdermal drugs, sublingual drugs, intranasal drugs, and inhalant drugs, to include drugs administered by any means of administration and, to include, by any product that effects an animal's body. As previously alluded, the shelf life may be the amount of time remaining before unused pharmaceutical products become unsuitable and the expiration may be the amount of time remaining before previously accessed or opened pharmaceutical products, such as injectable drugs, become unsuitable.

The remote server 24 communicates bidirectionally with medical office 22, vendor 26, distributor 28, and institution 25 and can analyze any data received. For example, remote server 24 can receive pharmaceutical product usage data from medical office 22 and analyze this usage data to generate usage analysis data. From the usage analysis data, it can be determined if certain diseases are breaking out, pharmaceutical product needs can be forecast, representative efficiency can be tracked, and so forth. A spike in the increased usage of a pharmaceutical product to treat a disease may occur before a spike in the increased ordering of that pharmaceutical product. This can be because a medical facility orders its pharmaceutical product when its inventory is low, i.e., the medical facility uses its inventory of the pharmaceutical product before ordering more. Going further, usage data and the usage analysis data can be shared with vendor 26, distributor 28, and institution 25.

Institution 25 can be a government body, federal agency, school, institution of higher learning, and so forth. The institution 25, e.g., the Centers for Disease Control (CDC), can monitor the usage data or the usage analysis data to track instances of disease.

Vendor 26 can be any vendor, manufacturer, producer, etc. of pharmaceutical products. Vendor 26 can sell pharmaceutical products directly to medical office 22 or indirectly, e.g., via distributor 28. The vendor 26 can monitor the usage data or the usage analysis data to forecast and/or control its inventory of the pharmaceutical product and to gauge the effectiveness of any of its representatives or distributors.

Distributor 28 can be any distributor of pharmaceutical products. Distributor 28 resells pharmaceutical products to medical office 22 that were bought from, e.g., vendor 26. The distributor 28 can monitor the usage data or the usage analysis data to control its inventory of the pharmaceutical product and to gauge the effectiveness of any of its representatives or vendors. A vendor and a distributor can be the same entity, such as when a vendor produces, manufactures, and distributes its products and sells such products directly to medical offices. In such cases, the distributor 26 and vendor 28 may comprise different parts or interfaces of one or more computer network systems.

In one operational embodiment, the systems and methods are implemented as software as a service to doctors' offices with the input data being licensed or sold to production and distribution facilities on the supply side. With respect to drug samples, and particularly to injectable drugs, each drug sample and injection as well as injection vial must be manually logged in with existing systems. Moreover, not only is manual logging labor intensive, but ordering is labor intensive as well. The systems and methods presented herein provide a digital and unified way of provisioning pharmaceutical inventory. Quantity and shelf life are monitored as well as expiration of perishable pharmaceutical products such as injection vials that have been opened.

The use of a digital database to contain a log, along with the date/time of each entry (e.g., dispense, dispose, injection drawn) allows not only the doctor's office but the distributors and suppliers as well to have visibility into the pharmaceutical inventory. In one embodiment, this enables auto-reordering as well as important notifications, including recall, from the distributor and vendor to the doctor's office. More particularly, with respect to data, inventory data may include a sales representative's full name and company, drug name, drug strength, drug lot number, expiration date, quantity left at the location, and the doctor receiving the sample medication. Inventory data may also include a product name, product's standard (or default strength), lot/serial number, shelf life (unopened), expiration (once opened), date opened, status (e.g., shipped, in transit, disposed, dispensed), shipping information, manufacturer, and distributor.

Referring to FIG. 3, therein is depicted a data flow diagram of one embodiment of the system for the provisioning of pharmaceutical inventory. Data flows between a client device 70, remote server 24, distributor 28, and vendor 26. The client device 70 may be any device that accesses remote server 24, including a computer, laptop, cell phone, and so forth. Client devices 70 may be used by doctors or office staff of the medical office 22 and also by representatives of the distributor 26 and vendor 28. The client device 70 may host some or all of the local monitoring subsystem 16 and the disbursed tracking system 10, which may be achieved through the use of an Internet browser running on the client device 70. As noted above, there is two-way communication between the client device 70 and the remote server 24.

The remote server 24 is associated with the reconcile engine 14 that determines reorder times. The remote server 24 is typically hosted at a facility or office other than medical office 22, vendor 26, or distributor 28. The distributor 28 distributes the medical items from the vendor 26 to one or more medical offices 22. A distribution company owning the distributor 28 may have one more sales representatives that are responsible for selling or giving the medical/pharmaceutical products to the medical offices 22. These sales representatives may use the system to track the distribution of medical items.

The vendor 26 produces the medical items that are purchased by the one or more medical offices 22. A production company owning the vendor 26 may use the disbursed tracking system 10 to track the distribution of medical items. At 30, a client device 70 sends login information to the remote server 24, which receives the login information from the client device 70 at 32. The login information is used by the remote server 24 for authenticating and verifying access to the pharmaceutical provisioning system and the inventory data. As such, a user (e.g., a doctor, office staff, sales representative, or other authorized person) of client device 70 may have limited access to the inventory data based at least in part on the login information provided.

At 34, the remote server 24 sends inventory data to the client device 70, which receives the inventory data from the remote server 24 at 36. The inventory data is sent after the client device 70 is authenticated and verified with the login information. As discussed above, the inventory data includes at least information about the production, distribution, shipping, transit, and consumption of the pharmaceutical inventory. The inventory data may further include a log of all of the changes made to the inventory data. Such a log would allow for the collection and analysis of historical usage data of pharmaceutical products that could then be used to more accurately determine reorder times by the reconciliation engine 14 associated with the remote server 24.

At 38, the client device 70 sends input data to the remote server 24, which receives the input data from the client device 70 at 40. As discussed above, the input data includes at least information about the removal, reduction, recall, and the addition of pharmaceutical products to the inventory data. At 42, the remote server 24 sends unsuitability data to the client device 70, which receives the unsuitability data from the remote server 24 at 44. The unsuitability data indicates that one more pharmaceutical products are unsuitable for use because one of a shelf life has passed, an expiration has passed, or a warning for recall has been issued. The unsuitability data may be based on any of inventory data, input data, and recall data from the institution 25. For example, some medical items may expire as soon as they are opened such that when the input data indicates that such a medical item has been opened, the remote server 24 would then send unsuitability data indicating that the medical item is no longer suitable.

At 45, client device 70 sends a manual or first time order to remote server 24, which receives the manual or first time order at 47. A manual order is manually entered by medical office staff and a first time order is for the first time a pharmaceutical product is ordered by a medical office. At 46, vendor 26 (or optionally distributor 28) sends recall data to remote server 24, which receives the recall data from the vendor 26 (or distributor 28) at 48. This first recall data from a vendor, distributor, institution (not shown) indicates that one of more pharmaceutical products are unsuitable for patient use regardless of any shelf life, expiration, or recall warning that is associated with the pharmaceutical products.

At 50, the remote server 24 sends recall data to the client device 70, which receives this recall data from the remote server 24 at 52. This second recall data is based on the first recall data from the distributor or vendor to identify which pharmaceutical products are being recalled. The second recall data is also based on the inventory data so that data only pertinent to recall information is sent to a client device 70 and medical office 22. Put another way, a medical office 22 utilizing a client device 70 will only receive recall data and information for pharmaceutical products related to the inventory of the medical office 22 and will not receive information specific to the patient that, e.g., received an injection of an injectable drug.

At 58, the remote server 24 sends order data to the client device 70, which receives the order data from the remote server 24 at 60. The order data is for any of a manual order, a first time order, an automatic order, and a reorder. A manual order is placed by a user of the client device 70. A first time order is for the first time a pharmaceutical product is ordered. An automatic order is placed by the remote server using a subscription, as described further below. A reorder is for subsequent orders of pharmaceutical product after a first time order. The order data indicates at least an order date and an order quantity. Flags in the order data may be used to indicate different types of orders. For example, the order data may include a flag that indicates that an order is a first time order, i.e., the first time that pharmaceutical has been ordered by a medical office. The order date indicates when a pharmaceutical product should be ordered and the order quantity indicates how much of a pharmaceutical product should be ordered. The order data may be based on the inventory data and the input data. For example, when a pharmaceutical product is first entered into the inventory data, the order date of the order data may be based on the shelf life of the pharmaceutical product that was entered. Going further, when a pharmaceutical product is opened, the order date may be updated to the expiration of the pharmaceutical product. A medical office or other user of a client device 70 with appropriate permissions, can change the order date or order quantity, allow the system to automatically place the order, or cancel the order entirely based on the order data received at 60.

Types of orders include: manual orders, automatic orders, first time orders, and reorders. Manual orders are entered manually by medical office doctors or staff or a representative at a client terminal 70. Automatic orders are entered automatically, e.g., by a distributor or vendor. First time orders are orders where a medical facility orders a pharmaceutical product for the first time. Reorders are for subsequent orders of a pharmaceutical product.

At 62, the remote server 24 sends an order to one or both of the distributor 28 and vendor 26, which receives the order from the remote server 24 at 64 and 65, respectively. The order is based on the order data that was sent to the client device 70 at 58. This allows for the order to be automatically placed on the order date for the order quantity of a pharmaceutical product by the remote server 24. At 66, the remote server 24 sends a reorder notification to the client device 70, which receives the reorder notification from the remote server 24 at 68. The remote server 24 sends the reorder notification after sending the order at 62. This way, medical Office 22 can keep track of the orders that are placed on its behalf by the remote server 24.

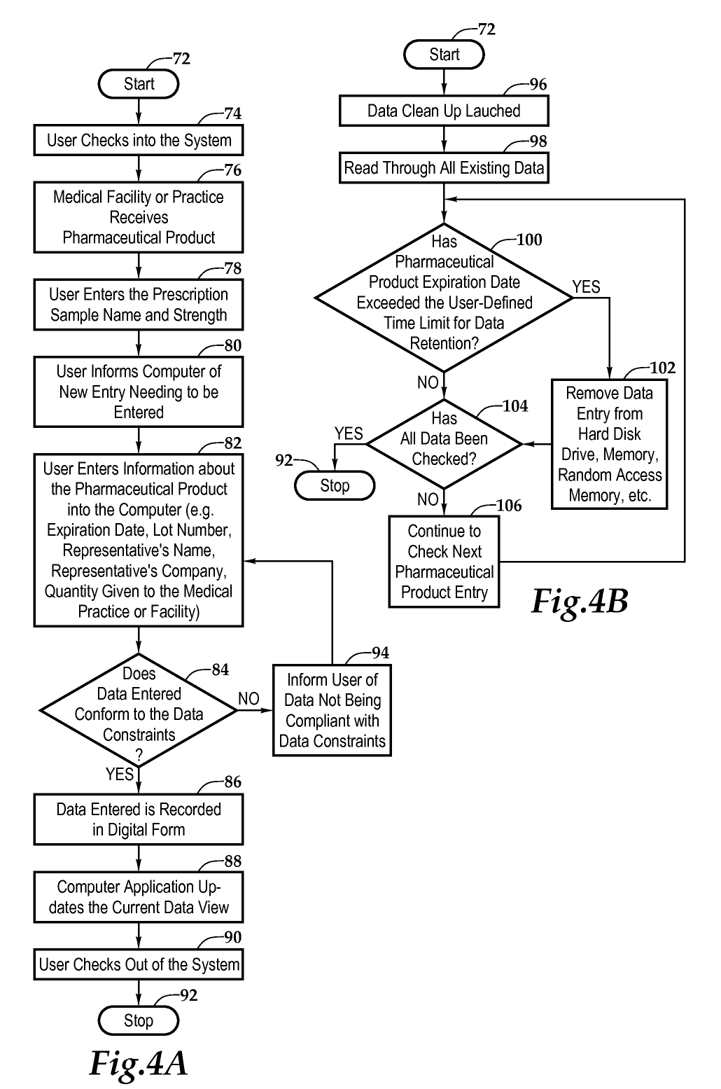

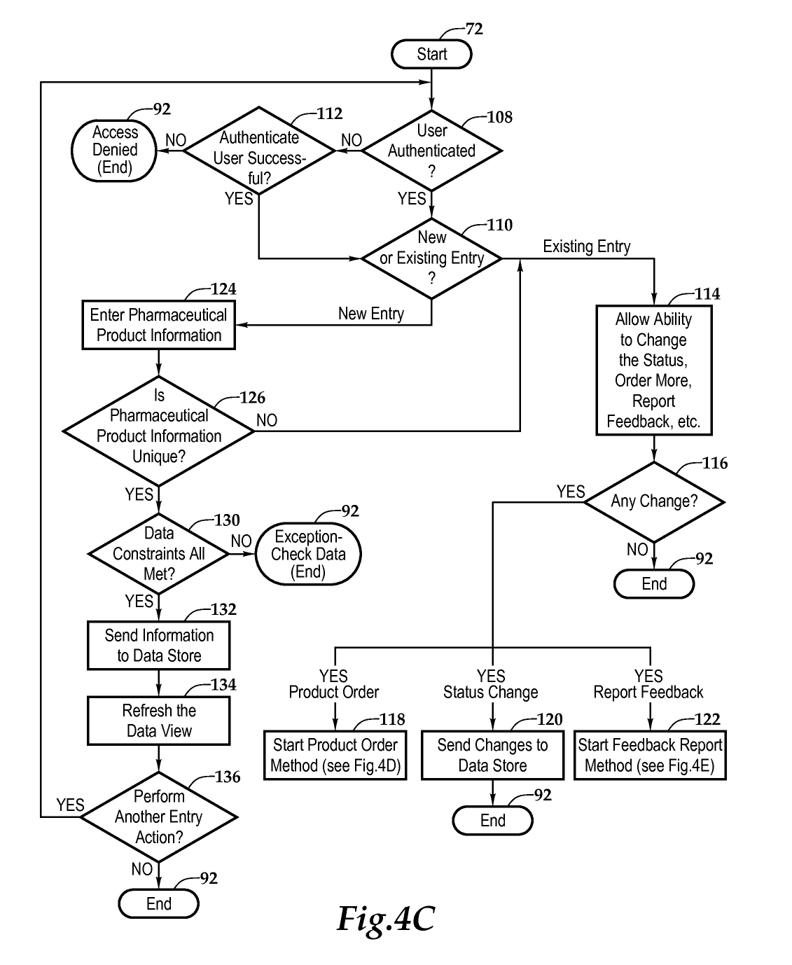

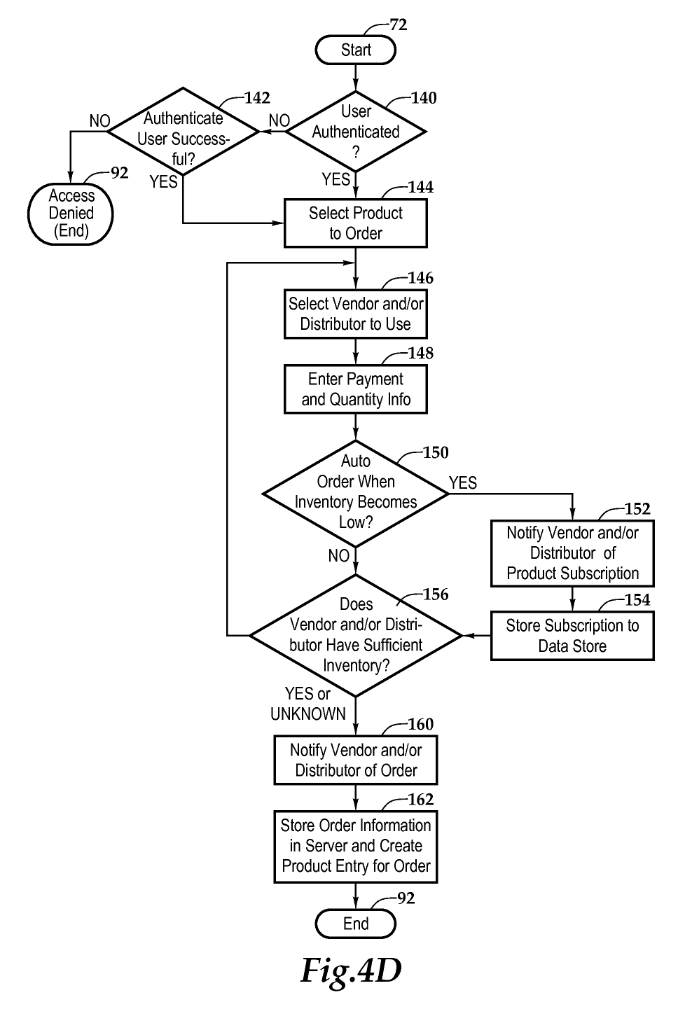

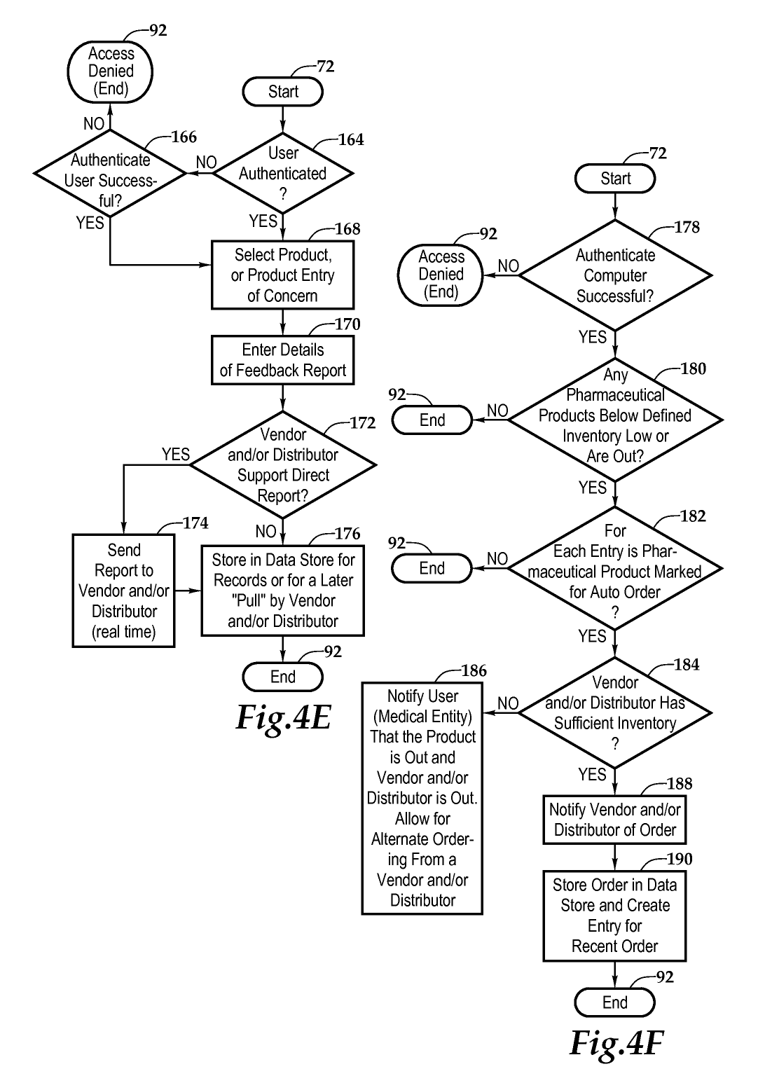

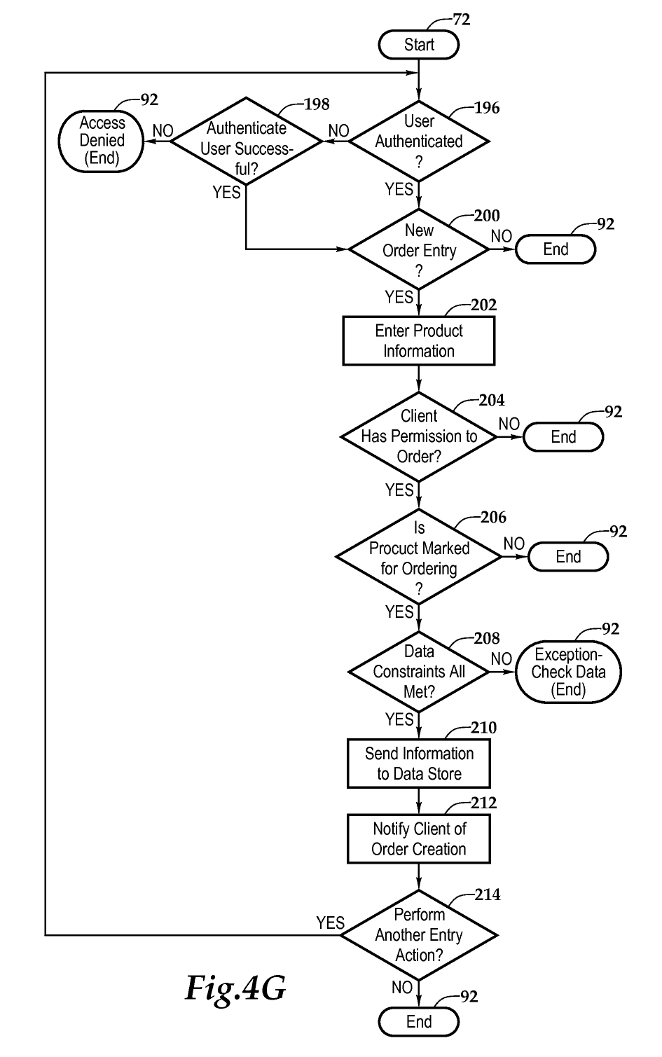

Referring to FIG. 4A, therein is depicted a flow chart depicting a method for data entry of pharmaceutical products. Data entry of the pharmaceutical products may be performed by a vendor's representative, distributor's representative, or medical facility staff, and allows for tracking of all of the medical and/or pharmaceutical products given out by representatives to a medical facility. At 72, the method starts up. At 74, a user, such as a pharmaceutical representative, checks into the system. At 76, a medical facility or practice receives a pharmaceutical product, such as a prescription sample. 76 may be performed in a physical form or by an indirect means. 76 is most commonly performed by a pharmaceutical representative of a vendor or distributor giving a prescription sample to a medical facility. At 78, the user enters the prescription sample name and strength. 78 may be combined with 82 below. At 80, the user indicates to the computer that a new entry needs to be entered. 80 may be omitted when 78 is combined with 82. At 82, the user enters information, e.g., input data, about the prescription sample related to the new entry from 80. The information may be anything that identifies the pharmaceutical product, including: expiration date, lot number, representative's name, representative's company, quantity given, and so forth.

At 84, the method checks the input data to see if it conforms with data constraints. For example, the method verifies that the expiration date is a date in the future, the lot number is a valid lot number, the representative's name is verified, the representative's company is verified, and that a quantity given is within appropriate minimum and maximum amounts. By checking the data against data constraints during the data entry, many errors from improper data input can be reduced.

If the input data does not properly conform, then at 94, the user is informed that the input data does not comply with the data constraints. The method then continues back to 82 where the user can correct and/or reenter the input data. If the input data does conform, then at 86, the input data is recorded in digital form. The input data may be stored in any digital medium, including: a hard disk drive, random access memory, and so forth. At 88 the computer application in use by the user, e.g., a local monitoring subsystem, updates the current data view. The data view is any view that shows the current data that resides in the computer, hard disk drive, random access memory, etc., being used by the user. At 90, the user checks out of the system. At 92, the method stops.

Referring to FIG. 4B, therein is depicted a flowchart depicting a method for data clean up. By cleaning up the data for entries of pharmaceutical products whose expiration date has exceeded a time limit for data retention, the size of the data store containing the medical facility's data is reduced. At 72, the method starts up. At 96, the method for data cleanup is launched, e.g., to clean up the data within the disbursed tracking system 10. The cleanup process can be launched via a variety of ways or triggers. Most commonly, the data cleanup process takes place at program startup. The data cleanup may be by the local monitoring subsystem 10 or by the disbursed tracking system 16.

At 98, the method reads through all the existing data to check on each instance of data related to a medical or pharmaceutical product. At 100, each instance of data is checked to see if the expiration date of the prescription sample exceeds a user defined time limit for data retention. If so, then at 102, the method removes the data entry from the hard drive, memory, random access memory, etc. At 104, the method determines if all of the data has been checked. If all the data has not been checked, then at 106, the method continues to check the next prescription sample entry. If all of the inventory data related to medical and pharmaceutical products has been checked, then at 92, the method ends.

Referring to FIG. 4C, therein is depicted a flowchart depicting a method for entering and/or editing pharmaceutical product data. The entry and editing of pharmaceutical product data allows for a medical facility to track all of its pharmaceutical product usage. Pharmaceutical product data is input data that is related to a pharmaceutical product received by the medical facility. Pharmaceutical products include injectable drugs, peroral drugs, oral drugs, topical drugs, transmucosal drugs, transdermal drugs, sublingual drugs, intranasal drugs, and inhalant drugs, regardless of purpose, including chemotherapy and vaccines. At 72, the method starts up. A user may enter data into the system using the local monitoring subsystem 16.

While a user may be authenticated to access the local monitoring subsystem 16, the user may not have privileges to access the disbursed tracking system 10 via the local monitoring subsystem 16. At 108, the method determines if the user is already authenticated. If the user is not already authenticated at 108, then at 112, the method attempts to authenticate the user. If the user is not successfully authenticated at 112, then access is denied and the method ends at 92. If the user was already authenticated at 108 or successfully authenticated at 112, then at 110, the user indicates whether the pharmaceutical product data is for a new or an existing entry.

If the pharmaceutical product data is for a new entry, then the user enters pharmaceutical product information at 124. pharmaceutical product information is any uniquely identifying information about the product, the product's use or usage, the product's expiration date, and so forth. At 126, the method determines if the pharmaceutical product information is unique. If the pharmaceutical product information is not unique, then the method will treat the entry of pharmaceutical product information as an existing entry and continue at 114, as described below. For example, when a medical facility receives a subsequent sample for the same prescription or pharmaceutical product from a distributor's representative.

If the pharmaceutical product information is unique, then at 130, the method determines whether all of the data constraints related to the pharmaceutical product information are met. If the data constraints not all met at 130, then at 92, the method ends, and may optionally indicate to the user that an exception occurred when checking the data against the data constraints. If all of the data constraints are met at 130, then at 132, the pharmaceutical product information is sent to a data store. At 134, the method refreshes the data view, similar to 88.

At 136, the method determines whether another entry action should be performed. If another entry action is to be preformed, then the method proceeds back to 108 to determine if the user is authenticated. By proceeding back to 108 and checking the authentication of the user, extra security is provided. If another entry action is not to be performed then the method ends at 92. If the pharmaceutical product information is for an existing entry at 110, then at 114, the user is given the ability to change the status of the entry, order more of that product, start a feedback report, and so forth. The status is the status of the tracked product or pharmaceutical item. For example, a product's status may include: in shipping transit, shipped, waiting for pickup, and so forth. A feedback report may be in reference to the tracking, to the product itself, the distributor, the representative of the distributor, the vendor, the representative of the vendor, and so forth. For example, the feedback report can alert a vendor or distributor to any supply chain issues and also to the success, tolerance, and effectiveness of the pharmaceutical product. At 116, the method determines if there is any change to the existing entry. If there is no change to the existing entry at 116, then at 92, the method ends.

If the existing entry is to be changed at 116 by placing a product order, then at 118, the method starts a product order method, as further described below with reference to FIG. 4D. If the existing entry is to be changed at 116 by a feedback report, then at 122, the method starts a feedback report method, as further described below with reference to FIG. 4E. If the existing entry is not to be changed at 116, then the method ends at 92. If the existing entry is to be changed at 116 by changing the status, then at 120, the method sends the changes to the data store. At 92, the method ends.

Referring to FIG. 4D, therein is depicted a flowchart depicting a method for manually ordering pharmaceutical products. In addition to simply manually ordering pharmaceutical products, the method provides that a subscription may be set up for a pharmaceutical product to be automatically ordered at future dates. At 72, the method starts up. At 140, the method determines if the user is already authenticated. If the user is not already authenticated at 140, then at 142, the method attempts to authenticate the user. If the user is not successfully authenticated at 142, then access is denied and the method ends at 92.

If the user was already authenticated at 140 or successfully authenticated at 142, then at 144, the user selects a product to order. At 146, the user selects a vendor and/or distributor to use and from which to receive the product. At 148, the user enters payment and quantity information for the product order of the pharmaceutical product. At 150, the user indicates whether a subsequent order should automatically be entered when inventory for the product becomes low. The definition of what low inventory is for a product is defined by the user and is on a per product basis. If the user indicates a subsequent order should automatically be entered when inventory becomes low, then at 152, a server that received the information from the user (e.g., a server of the disbursed tracking system 10) notifies the vendor and/or distributor of a subscription to that product. By informing the vendor/distributor, the vendor/distributor is better able to track and anticipate its own supplies of that product. By subscribing to automatically ordering pharmaceutical products, the medical facility can spend less time and effort checking its inventory of pharmaceutical products and more time focusing on its patients. At 154, the subscription is stored to the data store. This subscription may also be part of the usage data or usage analysis data as described above that can be used to control or forecast inventory or predict disease outbreaks.

If the user indicates a subsequent order should not automatically be entered when inventory becomes low at 150 or after the subscription data was stored at 154, then the method determines if the vendor and/or distributor has sufficient inventory at 156. If the vendor and/or distributor does not have sufficient inventory, then going back to 146, the user may select another vendor and/or distributor. The user may leave the subscription to the original distributor and place a onetime order to the alternate vendor and/or distributor for the pharmaceutical product. Alternatively, the user may change the subscription so that it is also to the alternate vendor and/or distributor. In this case, the original vendor and/or distributor will be notified that the user is no longer subscribing to that product. When an alternate vendor and/or distributor is selected, the feedback report, as discussed below, may be automatically generated with or without input from the user. If the vendor and/or distributor has sufficient inventory or if it is unknown whether the vendor and/or distributor has sufficient inventory, then at 160, a server notifies the vendor and/or distributor of the order. At 162, the order information is stored in the server and a product entry is created for the order. At 92, the method ends.

Referring to FIG. 4E, therein is depicted a flowchart depicting a method for handling a feedback report. By providing feedback reports that can be created by a user of a medical facility and shared with vendor and distributors, the system provides for a quicker resolution of any issues that can arise between a medical facility and a vendor and/or distributor. The system also provides for faster feedback to the vendor/distributor of information related to the success, tolerance, and effectiveness of the pharmaceutical product as well as information regarding the effectiveness of representatives. At 72, the method starts up. At 164, the method determines if the user is already authenticated. If the user is not already authenticated at 164, then at 166, the method attempts to authenticate the user. If the user is not successfully authenticated at 142, then access is denied and the method ends at 92.

If the user was already authenticated at 164 or successfully authenticated at 166, then at 168, the user selects which product or product entry is of concern and is to be detailed in the report. At 170, the user enters the details of the feedback report. The details of the report include any data about the report. This can be via a free form field or even a survey that the user fills out and may include any data related to the product.

At 172, the method determines if the distributor supports receiving feedback reports directly. If the vendor and/or distributor supports receiving feedback reports directly, then at 174, the server implementing the method sends the feedback report to the vendor and/or distributor. Sending the report may be done in real time as the user creates the report. This way, a vendor and/or distributor can be immediately informed of any issues, problems, or feedback related to its products, distribution, and representatives.

If the vendor and/or distributor does not support direct reports (172) or after the report was sent to the vendor and/or distributor at 174, then at 176, the report is stored in a data store for later use and record keeping. The report can be pulled later by the vendor and/or distributor. For example, a distributor may pull reports periodically, such as once per day or once per month, so as to save network bandwidth. Depending upon the nature of the report, the user or the distributor may decide to alter any of the subscriptions related to any of the products related to the feedback report. For example, the user may indicate that a product is not of high enough quality and discontinue the subscription for that product from that distributor. At 92, the method ends.

Referring to FIG. 4F, therein is depicted a flowchart depicting a method for automatic order placement. With automatic order placement, a medical facility can spend less time and effort on checking its inventory and focus more on treating its patients and the distributor/vendor can better track its inventory of pharmaceutical products. At 72, the method starts up. At 178, the method determines if a computer that is automatically placing the order is authenticated. In order to place the order the computer may be acting as a virtual user of the system. If the computer was not authenticated at 178, then access is denied and the method ends at 92. If the computer was already authenticated at 178, then at 180, it is determined if any of the products are below their respective predefined inventory lows or are completely out. If none of the products are below their respective predefined inventory lows and are not completely out at 180, then the method ends at 92.

If any pharmaceutical products (e.g., injectable drugs, pharmaceutical items, medical items, peroral drugs, oral drugs, topical drugs, transmucosal drugs, transdermal drugs, sublingual drugs, intranasal drugs, inhalant drugs, and so forth) are below their respective predefined inventory lows or are completely out at 180, then at 182, it is determined for each entry whether the product associated with that entry is marked for automatic ordering. If at 182 there are no products that are marked for automatic ordering, then method ends at 92. Whether a product is marked for automatic ordering can be based on many criteria, including: the cost of the product, the anticipated use of the product, how often the product is used, and so forth.

For the products that are marked for automatic ordering at 182, a server implementing the method determines if the vendor and/or distributor of the product has sufficient inventory at 184. If it is determined that a product's vendor and/or distributor does not have sufficient inventory at 184, then at 186, a user (e.g., a medical facility) is notified that the product is out and that the vendor and/or distributor is out. This allows for ordering from an alternate vendor and/or distributor. After being notified, the user can manually order from an alternate vendor and/or distributor and may also change the automatic order so that it may also use the alternate vendor and/or distributor, as discussed above with reference to FIG. 4D. When the user is notified that the product is out and the vendor and/or distributor is out, a feedback report may be automatically generated with or without user input. The feedback report may itself serve as the notification to at least one of the user, the vendor, and the distributor.

If it is determined that a product's vendor and/or distributor does have sufficient inventory at 184, then at 188, the vendor and/or distributor is notified of the order without any input required from the user. At 190, the order is stored in a data store and entries are created for the recent order that may be viewed by any of the medical facility, the distributor, and the vendor, depending upon who has access to this data within the disbursed tracking system. At 92, the method ends.

Referring to FIG. 4G, therein is depicted a flowchart depicting a method for entering order data. A vendor and/or distributor can enter this order data on behalf of a medical office. The entry of the order data by a vendor and/or distributor allows for a medical facility to concentrate more on its patients and allows to vendor and/or distributor to better control its inventory. At 72, the method starts up.

The user may not have privileges to access the disbursed tracking system 10. As such, at 196, the method determines if the user is already authenticated. If the user is not already authenticated at 196, then at 198, the method attempts to authenticate the user. If the user is not successfully authenticated at 198, then access is denied and the method ends at 92. If the user was already authenticated at 196 or successfully authenticated at 198, then at 200, the user indicates whether the order data is for a new order entry. If the order data is not for a new order entry, then the process ends at 92.

If the order data is for a new order entry, then the user enters product information at 202. Product information is any uniquely identifying information about the order, the pharmaceutical product, the product's use or usage, the product's expiration date, and so forth. At 204, it is determined if the client has permission to place the order. Each medical office can determine which pharmaceutical products can be ordered by clients controlled by the medical office. If the client does not have permission to place the order, then the process ends at 92.

If the client has permission to place the order, then at 206, the method determines if the pharmaceutical product is marked for ordering. Each vendor and distributor can determine which pharmaceutical products can be ordered by the distributor/vendor on behalf of the medical office. If the pharmaceutical product is not marked for ordering, then the method ends at 92.

If the pharmaceutical product is marked for ordering, then at 208, the method determines whether all of the data constraints related to the product information are met. If the data constraints not all met at 208, then at 92, the method ends, and may optionally indicate to the user that an exception occurred when checking the data against the data constraints. If all of the data constraints are met at 208, then at 210, the product information is sent to a data store and the order is created. At 212, the method notifies the client of the order creation.

At 136, the method determines whether another order should be placed. If another order is to be placed, then the method proceeds back to 196 to determine if the user is authenticated. By proceeding back to 196 and checking the authentication of the user, extra security is provided. If another entry action is not to be performed then the method ends at 92.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A system for provisioning a pharmaceutical inventory including a plurality of pharmaceutical products, the system comprising:
a local monitoring subsystem located at a medical office, the local monitoring subsystem including an interface configured to input data relative to the pharmaceutical inventory, the input data including information about the removal, reduction, recall, and the addition of pharmaceutical products;
a disbursed tracking subsystem distributed through the medical office, the remote server, production facility, and the distribution facility, the disbursed tracking subsystem including a memory that stores inventory data about the pharmaceutical inventory, the inventory data including information about the production, distribution, shipping, transit, and consumption of the pharmaceutical inventory;
a reconcile engine associated with the remote server in communication with the local monitoring subsystem for comparing the input data and the inventory data to determine reorder times for the pharmaceutical inventory; and
the reconcile engine monitoring the shelf life and expiration of the pharmaceutical products, the shelf life being the amount of time remaining before unused pharmaceutical products become unsuitable and the expiration being the amount of time remaining before previously accessed pharmaceutical products become unsuitable.

2. The system as recited in claim 1, wherein the pharmaceutical products include items selected from the group consisting of drug samples, injectable drugs, peroral drugs, oral drugs, topical drugs, transmucosal drugs, transdermal drugs, sublingual drugs, intranasal drugs, and inhalant drugs.

3. The system as recited in claim 1, wherein the expiration of the pharmaceutical products relates to the remaining life of injectable drugs.

4. A method for provisioning a pharmaceutical inventory including a plurality of pharmaceutical products, the method comprising:
receive login information from a client device for authenticating and verifying access to a pharmaceutical provisioning system;
send inventory data to the client device after the client device is authenticated and verified, the inventory data including information about the production, distribution, shipping, transit, and consumption of the pharmaceutical inventory;
receive input data from the client device, the input data including information about the removal, reduction, recall, and the addition of pharmaceutical products to the inventory data;
send unsuitability data to the client device, the unsuitability data indicating that one more pharmaceutical products are unsuitable for use because one of a shelf life or an expiration has passed, the shelf life being the amount of time remaining before unused pharmaceutical products become unsuitable and the expiration being the amount of time remaining before previously accessed pharmaceutical products become unsuitable;
receive first recall data from one of a distribution facility or a production facility, the first recall data indicating that one or more pharmaceutical products are unsuitable for patient use regardless of shelf life and expiration;
send second recall data to the client device, the second recall data based on the first recall data and the inventory data;
send order data to the client device, the order data indicating an order date and an order quantity, the order date indicating when a pharmaceutical product should be ordered, and the order quantity indicating how much of the pharmaceutical product should be ordered;
send an order to the distribution facility based on the order data; and
send a reorder notification to the client device after sending the order.

5. The method as recited in claim 4, wherein the pharmaceutical products include items selected from the group consisting of drug samples, injectable drugs, peroral drugs, oral drugs, topical drugs, transmucosal drugs, transdermal drugs, sublingual drugs, intranasal drugs, and inhalant drugs.

6. The method as recited in claim 4, wherein the expiration of the pharmaceutical products relates to the remaining life of injectable drugs.

7. The method as recited in claim 4, wherein the order data is based on the inventory data and the input data.

8. The method as recited in claim 4, wherein the order is automatically placed on the order date for the order quantity of a pharmaceutical product.

9. The method as recited in claim 4, wherein the unsuitability data is based on the inventory data and the input data.

10. The method as recited in claim 4, wherein the inventory data further includes a log of all of the changes made to the inventory data.

11. The method as recited in claim 4, wherein the order data is related to an order selected from the group consisting of a manual order, a first time order, an automatic order, and a reorder.

12. An apparatus for provisioning a pharmaceutical inventory including a plurality of pharmaceutical products, the apparatus comprising:
means for receiving login information from a client device, the login information for authenticating and verifying access to a pharmaceutical provisioning system;
means for sending inventory data to the client device after the client device is authenticated and verified, the inventory data including information about the production, distribution, shipping, transit, and consumption of the pharmaceutical inventory;
means for receiving input data from the client device, the input data including information about the removal, reduction, recall, and the addition of pharmaceutical products to the inventory data;
means for sending unsuitability data to the client device, the unsuitability data indicating that one more pharmaceutical products are unsuitable for use because one of a shelf life or an expiration has passed, the shelf life being the amount of time remaining before unused pharmaceutical products become unsuitable and the expiration being the amount of time remaining before previously accessed pharmaceutical products become unsuitable;
means for receiving first recall data from one of a distribution facility or a production facility, the first recall data indicating that one or more pharmaceutical products are unsuitable for patient use regardless of shelf life and expiration;
means for sending second recall data to the client device, the second recall data based on the first recall data and the inventory data;
means for sending order data to the client device, the order data indicating an order date and an order quantity, the order date indicating when a pharmaceutical product should be ordered, and the order quantity indicating how much of the pharmaceutical product should be ordered;
means for sending an order to the distribution facility based on the order data;
means for sending a reorder notification to the client device after sending the order;
wherein the pharmaceutical products include items selected from the group consisting of drug samples, injectable drugs, peroral drugs, oral drugs, topical drugs, transmucosal drugs, transdermal drugs, sublingual drugs, intranasal drugs, and inhalant drugs;
wherein the expiration of the pharmaceutical products relates to the remaining life of injectable drugs;
wherein the order data is based on the inventory data and the input data;
wherein the order is automatically placed on the order date for the order quantity of a pharmaceutical product;
wherein the unsuitability data is based on the inventory data and the input data;
wherein the inventory data further includes a log of all of the changes made to the inventory data; and
wherein the order data is related to an order selected from the group consisting of a manual order, a first time order, an automatic order, and a reorder.
